(19) United States
(12) Patent Application Publication
(10) Pub. No.: US 2006/0137161 A1
(43) Pub. Date: Jun. 29, 2006

(54) Side acting extractor tool

(76) Inventor: Kenneth E. Persson, East Rochester, NY (US)

Correspondence Address: KENNETH E. PERSSON, PO BOX 744, East Rochester, NY, 14445, US

(21) Appl. No.: 10/727,463

(22) Filed: Dec. 4, 2003

(51) Int. Cl. B25B 27/00; B23P 19/00

(52) U.S. Cl. 29/270; 29/426.5

(57) ABSTRACT

A side acting extractor tool of the present disclosure suitable for extracting from a keyway a broken key portion of a cut key includes a handle member; a blade member having a first end for connecting to the handle member, and a second and distal end for inserting into the keyway containing the broken key portion. The blade member is made of a spring material having a shim-like thickness for inserting into a clearance gap between the broken key portion and a wall of the keyway. The blade member also includes a longitudinal axis, and a deflectable finger portion having a memory position and extending sideways at an angle from the longitudinal axis for hooking against a part of the broken key portion, thereby enabling extraction of the broken key portion from the keyway by withdrawing the inserted blade member from the keyway.

### RELATED APPLICATIONS

This application is related to U.S. application Ser. No. ______ (patentee's docket KP002) entitled “Contoured Jaw Extractor Tool And Method”; having a common inventor, and filed on the same date herewith.

### BACKGROUND OF THE DISCLOSURE

This invention relates for example to locks of the kind having pin or other types of tumblers arranged to be displaced by an appropriately cut or cut key in order to enable opening of the lock by permitting a movable portion of the lock to be moved relative to the main body or cylinder of the lock. This invention more particularly relates to a method and an extractor tool having a contoured jaw for extracting broken pieces from a recess, for example, broken key portions of such keys from keyways of such locks. It will be convenient hereinafter to describe all aspects of this invention with particular reference to pin and wafer locks, but it is to be understood that the invention may be applied to other types of members having broken pieces therein, and to locks having other types of tumblers.

It is not uncommon for the end portion of a key to break off in a lock keyway, particularly an automobile ignition lock utilizing tumblers. Such automobile locks usually constitute the primary electrical switch for the vehicle and employ the key to impose a torque on the switch once the key is properly inserted, and keys are often bent or otherwise stressed due to the forces imposed thereon during use. When a portion of the automobile ignition key is broken off within the lock keyway or slot, such broken end is usually inaccessible, thus preventing the ignition switch from being operated and rendering the vehicle inoperative. Until the inaccessible broken key end portion is removed from the lock, operation of the vehicle is usually prevented. Broken key extractors are known and such devices may use a variety of tools for endeavoring to coax the broken key end from the lock. Adhesives, hook probes, and the like, may be used. However, the difficulty encountered in removing broken keys from locks often is so great that the lock must be entirely replaced at considerable expense.

U.S. Pat. No. 6,052,883 Apr. 25, 2000 and U.S. Pat. No. 6,260,253 issued Jul. 17, 2001, both to Kimzey each discloses a multiple, separate component extractor system tool for removing inaccessible broken key portions from keyways of locks. The extractor system tool consists of a separate pliers-like spreader tool for inserting into a keyway to displace any interfering tumblers, and a pair of thin elongated elements capable of being inserted into the lock on opposite sides of the broken key end portion and wherein twisting of the elements allegedly grips the broken key end to permit extraction from the lock. Extraction is aided by the pliers-like spreader tool having thin jaws inserted into the lock keyway for retracting lock tumblers, the dust shutter door and buzzer electric switches so as to prevent such items from interfering with the key extraction. As is obvious, this extractor system tool is not very convenient or efficient to use particularly because it literally requires three hands to use, one for each of the pair of elements and a third for the pliers-like spreader.

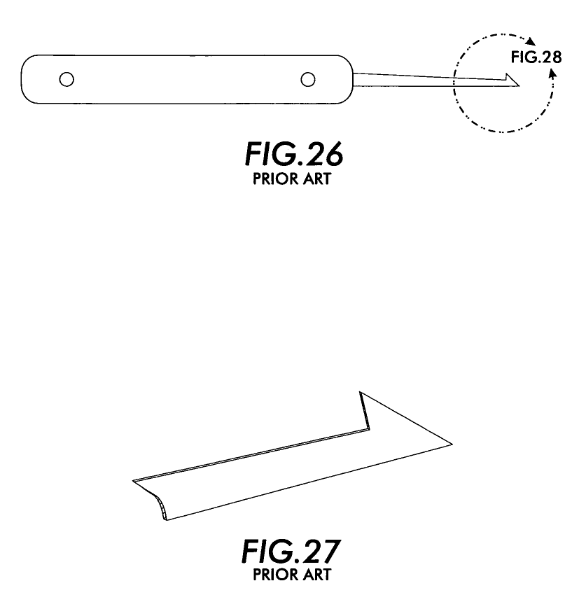

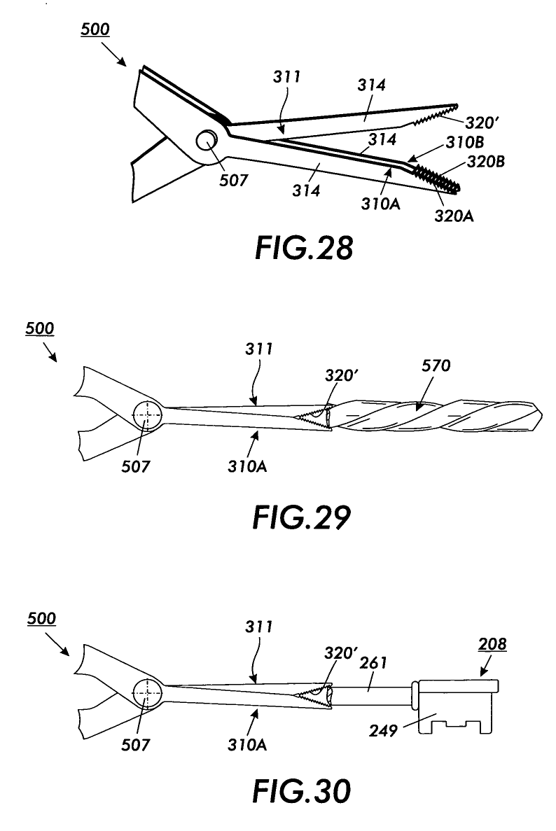

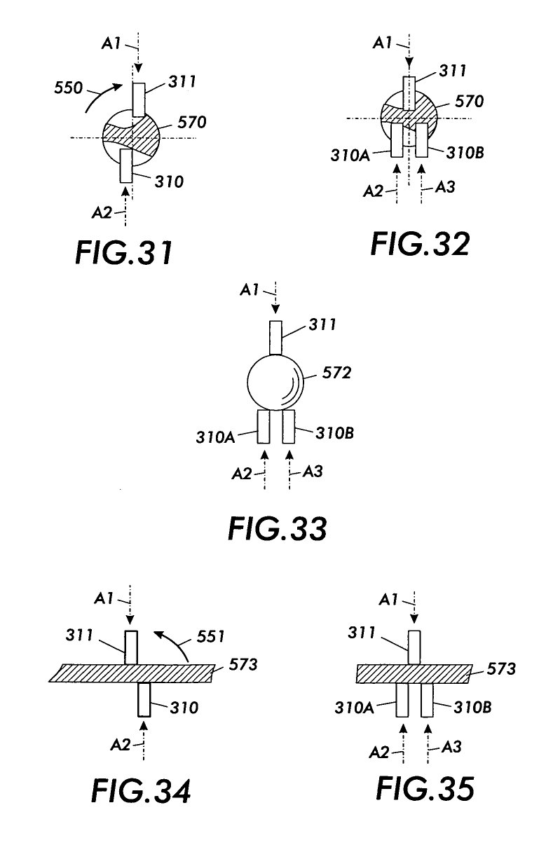

Other prior art such as disclosed in the last two figures, FIGS. 25 and 26, comprises a straight tool shaft having a single tooth or hook, usually a rigid shaft with a fixed, rigid tooth or hook intended for somehow grabbing the broken key portion from within the keyway. Such a prior art tool has been found not to have the angularity required to insure good tooth or hook bite into the broken key portion, and the single tooth or hook does not provide sufficient grabbing of the broken key portion for efficient extraction. This prior art tool also does not have tip or distal end features for enabling effective prying and ramping of tumbler pins resting partially or fully on the broken key portion within the keyway.

There is therefore still a need for a simple, single, one hand, effective and efficient extractor tool for efficiently extracting a loose item such as a broken key portion from a slot such as a keyway.

In accordance with the present disclosure, there is provided a side acting extractor tool that is a simple one tool, one hand, effective and efficient way of extracting broken key portions from keyways of almost any kind of lock. As illustrated and described, the side acting extractor tool of the present disclosure is suitable for extracting from a keyway a broken key portion of a cut key where the broken key portion. The side acting extractor tool of the present disclosure includes a handle member; a blade member having a first end for connecting to the handle member, and a second and distal end for inserting into the keyway containing the broken key portion. The blade member is made of a spring material having a shim-like thickness for inserting into a clearance gap between the broken key portion and a wall of the keyway. The blade member also includes a longitudinal axis, and a deflectable finger portion having a memory position and extending sideways at an angled from the longitudinal axis for hooking against a part of the broken key portion, thereby enabling extraction of the broken key portion from the keyway by withdrawing the inserted blade member from the keyway.

In the detailed description of the disclosure as presented below, reference is made to the drawings in which:

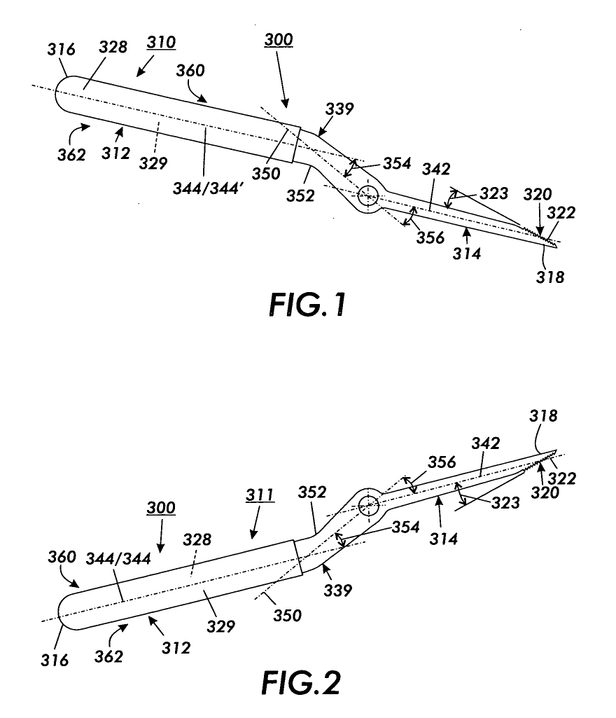

FIG. 1 is a schematic edge view of a first embodiment of the extractor tool of the present disclosure;

FIG. 2 is a schematic side view of the tool of FIG. 1;

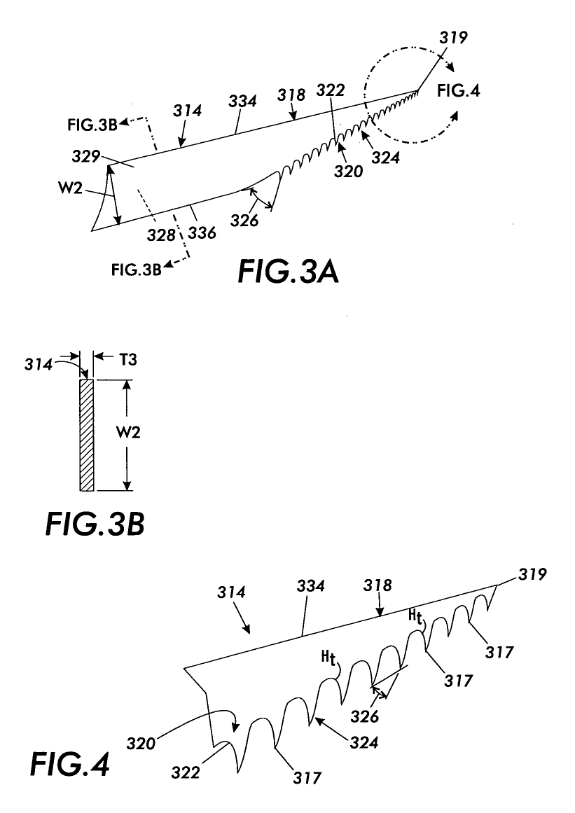

FIG. 3 is an enlarged schematic of the distal tip of the tool of FIG. 1 showing the adjustable extraction angle of the deflectable finger portion;

FIG. 4 is an enlarged illustration of the distal end of the tool of FIGS. 1 and 2 showing the deflectable finger portion thereof;

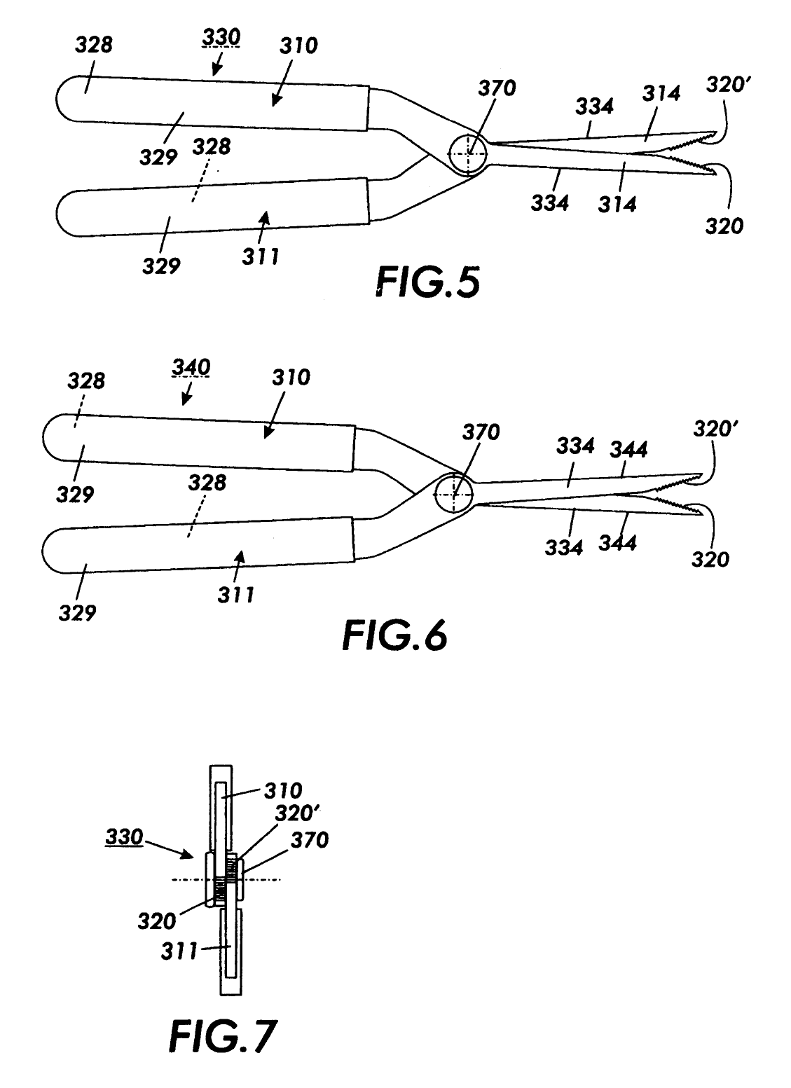

FIGS. 5-7 are similar illustrations of a second embodiment of the extractor tool of the present disclosure;

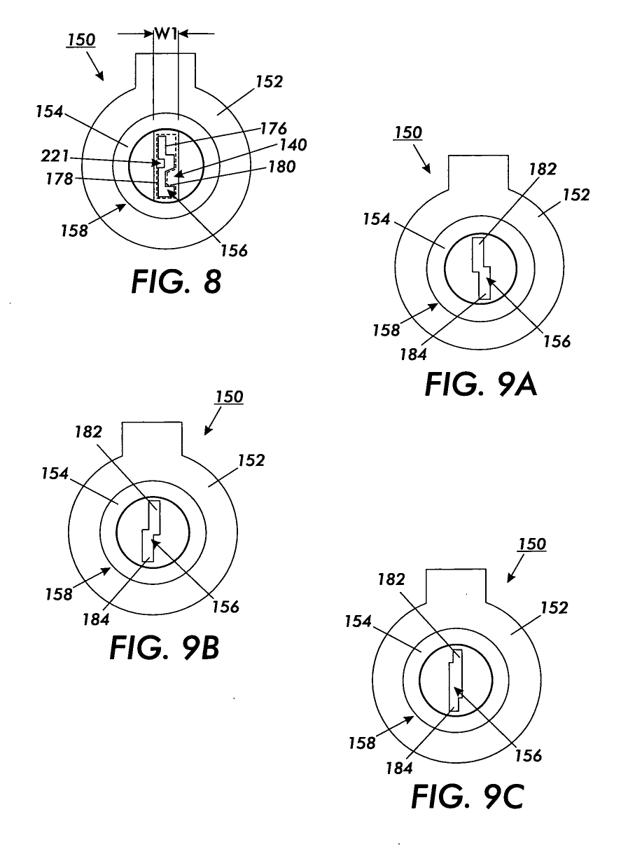

FIGS. 8-9C are each an end view of left-over-right and right-over-left keyways of tumbler locks to which embodiments of the present disclosure are applicable;

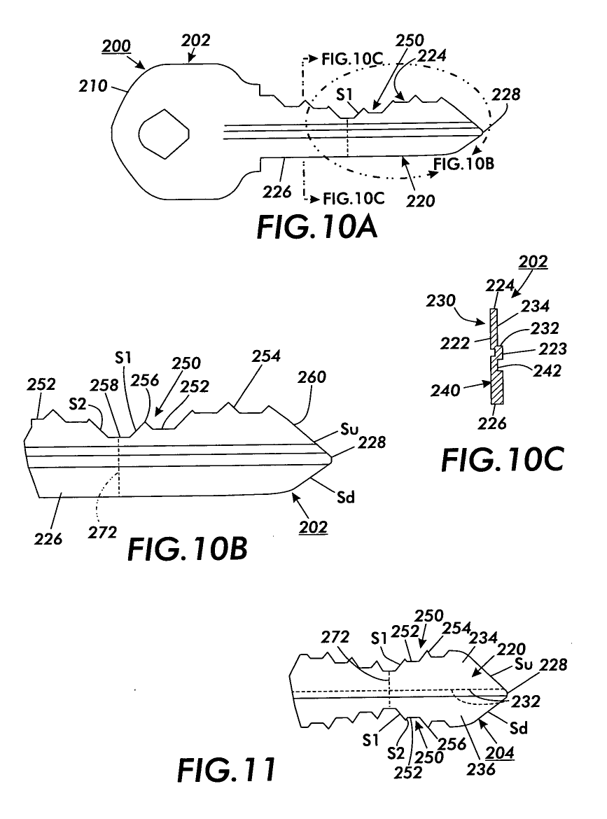

FIGS. 10A-10B are each a side view illustration of an exemplary single-cut key for use in accordance with the present disclosure;

FIG. 10C is a cross-sectional illustration of the exemplary single-cut key of FIG. 10A;

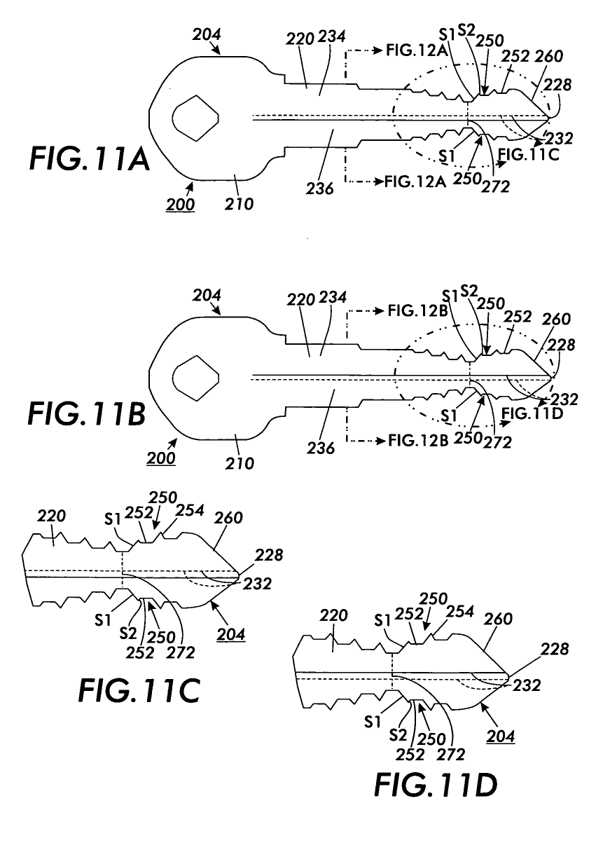

FIG. 11 is a side view illustration of an exemplary dual-edge cut key for use in accordance with the present disclosure;

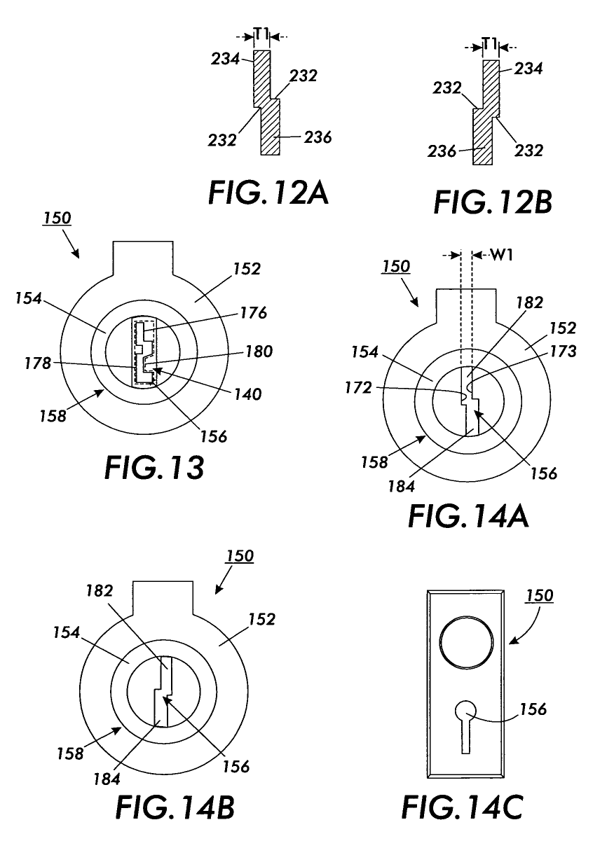

FIG. 12 is an enlarged longitudinal cross sectional view of an exemplary tumbler lock, for example a pin tumbler lock having an end view as in FIGS. 8-9C;

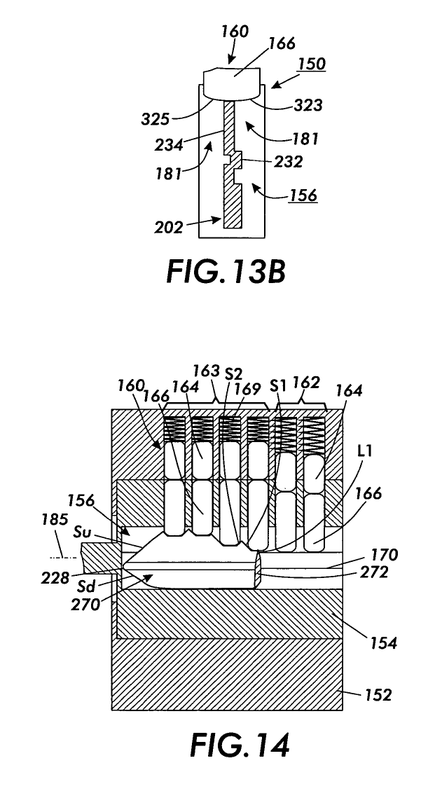

FIG. 13A is a schematic longitudinal cross sectional view of an exemplary tumbler lock, for example a single pin-series tumbler lock showing a correct single-cut key inserted therein;

FIG. 13B is a cross-sectional illustration of the exemplary single-cut key showing the bottom of a pin overhanging the key blade within a keyway;

FIG. 14 is an illustration similar to FIG. 13A showing a broken key portion within the keyway requiring extraction;

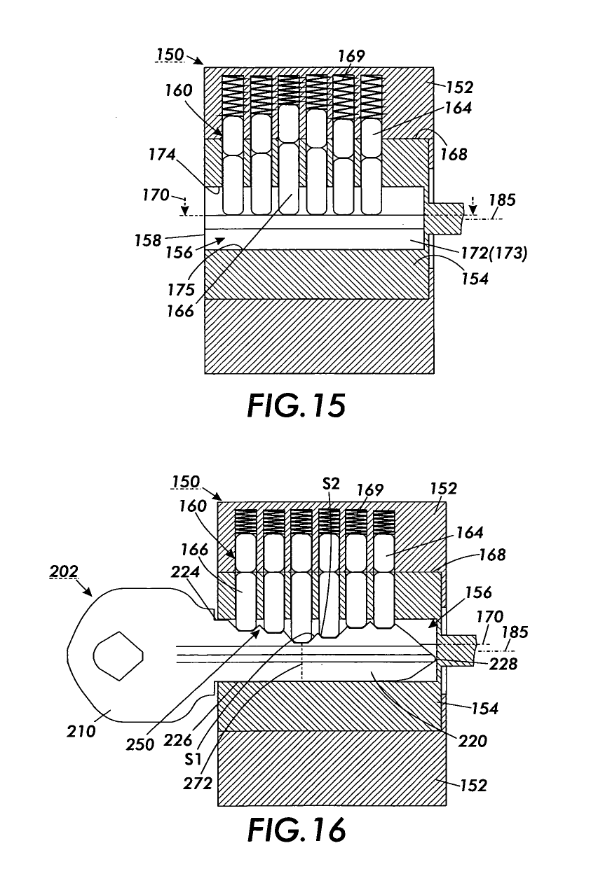

FIG. 15 is a schematic illustration of the extractor tool of the present disclosure being inserted into the keyway;

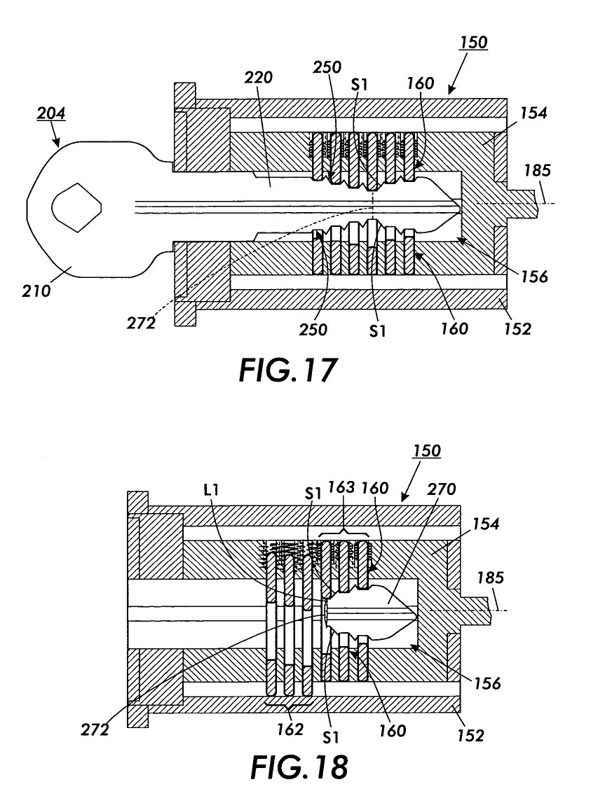

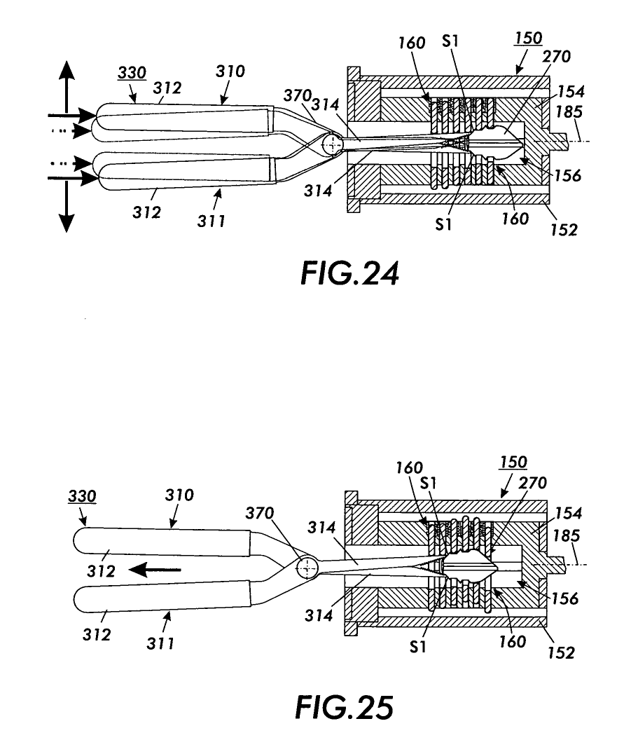

FIGS. 16-18 and FIGS. 22-24 are schematic illustrations of the extractor tool of the present disclosure showing the deflectable finger portion in catching relationship behind a declining slope on the broken key portion within the keyway;

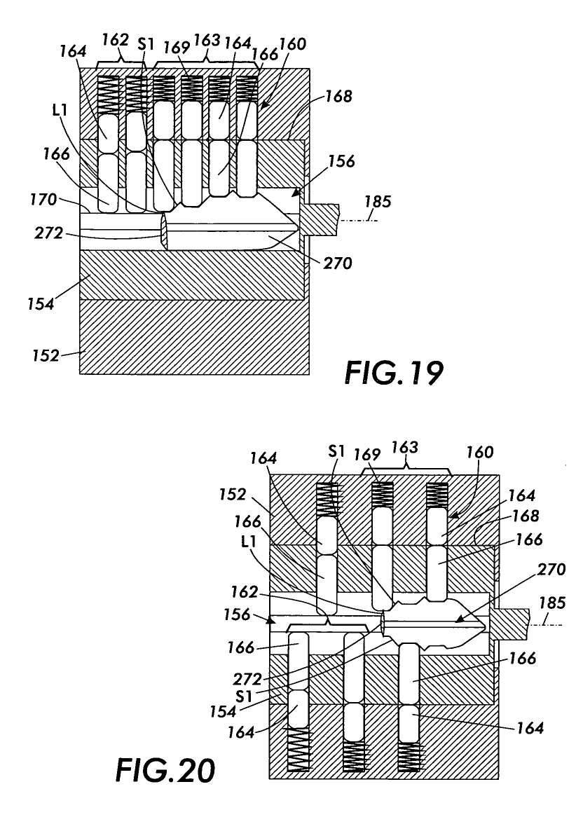

FIGS. 19-21 are schematic illustrations of the extractor tool of the present disclosure showing the deflectable finger portion in catching relationship behind an inclining slope on the broken key portion within the keyway, and use of an auxiliary tool;

FIG. 25 is a schematic side view of an exemplary prior art extractor tool for comparison; and

FIG. 26 is an enlarged illustration of the fixed, rigid single tooth of the prior art tool of FIG. 25.

### DETAILED DESCRIPTION OF THE DISCLOSURE

While the present disclosure will be described in connection with a preferred embodiment thereof, it will be understood that it is not intended to limit the disclosure to that embodiment. On the contrary, it is intended to cover all alternatives, modifications, and equivalents as may be included within the spirit and scope of the invention as defined by the appended claims.

Referring first to FIGS. 8-9C, a lock 150 that is useful for the purpose of the present disclosure is illustrated. As shown, the lock 150 usually is comprised of a housing or outer cylinder 152, and a movable member or plug 154, for example a rotatable member that has a keyway 156 formed into it for receiving a key. Such a lock also includes locking devices or tumblers, such as pins or wafers 160, located within the movable member or plug 154. These locking devices are operatable by only the correct key (FIG. 13A) for allowing or enabling movement of the movable member or plug 154 within the housing 152.

A pin tumbler lock 150 is an example of such a lock. Generally as illustrated in FIG. 12, the keyway 156 has two oppositely facing and spaced apart wall surfaces 172, 173, a first edge, usually an upper edge 174, and a second and opposite edge, usually a bottom edge 175, with each of these edges extending longitudinally from an external opening 158, into the movable member or plug 154. For each lock and correct key combination, the keyway 156 is formed deep enough for completely accommodating a length of the front or shaft portion 220 (FIG. 10A) of the correct key. The keyway as such also has a width W1 lying between the two opposite wall surfaces 172, 173, and such width is generally represented by a width of the upper and lower keyway edges 174, 175 but is further reduced by a ward 180 of key entry restricting feature within the warded portion of the key way.

A tumbler lock 150 as such thus includes the keyway 156 formed through the front end 158 of the barrel and extending inwardly of the barrel in the longitudinal direction. For locking devices, the tumbler lock 150 as shown in FIG. 12, for example, includes groups of pin tumblers 160 that are mounted partially in the cylinder 152 and in the barrel 154 with each group or series being movable towards and away from a longitudinal axis 185 of the rotatable barrel. Usually each group of pin tumblers includes a first (for example upper) pin 164 and a second (or lower) pin 166, with the lower pin 166 of each group being mounted to move and intrude or interfere through part of the movable member or plug 154 into the keyway 156 in the absence of a correct key. Insertion of the correct key into such a lock (FIG. 13A) first moves or displaces the intruding tumbler pins 160 out of the keyway as well as aligns the first and second pins 164, 166 of each group at a shear line 168 that lies between the housing 152 and the barrel 154 so as to allow the barrel 154 to rotate within the cylinder or housing 152.

The terms “upper” and “lower” as used throughout the specification to describe the key 200, key blade 234, 236 and keyway 156, are not to be understood as limiting the disposition of those components. Such relative terms are used for convenience of description only and in actual use, the upper edge surface 226 for example may be located to the side or underneath. In the preferred construction hereinafter described, the upper edge surface 174 of the keyway is that edge through which the pin tumblers for a single-edge cut key intrude into the keyway 156. The corresponding edge surface 226 of a single-edge cut key 202 is that edge containing the cuts or bittings 250. Thus such locks 150 typically are installed with the locking pins 160 located on a top side so that dirt does not fall into channels within which these pins, wafers and working mechanisms are located. As such, we can refer to the part of the lock having the pin sets as being the top of the lock.

In other words, an exemplary lock for use with the present disclosure is a mechanical lock such as a tumbler lock 150 that has a housing or shell cylinder 152, a rotatable plug or inner cylinder 154, a keyway 156 formed longitudinally through the plug 154, and moveable locking members such as mechanical pins or wafers 160 that can be raised or lowered by insertion of a correct cut key 200 inserted through the keyway 156 into the lock. Insertion of the correct cut key causes repositioning of these pins 160 or wafers from their lowest or locking and keyway interfering positions 170 back to their opening or shear line 168 aligning positions, thereby allowing the inner cylinder or plug 154 to turn or rotate inside the lock housing or cylinder shell 152. Such rotation typically causes blocking sidebars (not shown), for example, to fall into a gap (not shown), thereby releasing the locking mechanism. Through various methods of attachment this turning of the inner plug facilitates some external movement that disengages a locking pawl or other security device allowing access to the item being protected by the lock.

Such locks 150 typically are installed with the locking pins 160 located on a top side so that dirt does not fall into channels within which these pins, wafers and working mechanisms are located. As such, we can refer to the part of the lock having the wafers or pin sets as being the top of the lock.

The keyway 156 as shown is linearly cut through the plug 154 or inner cylinder, and as viewed in cross section or from its end (FIG. 13A), the typical keyway 156 for a single-edge key 202 includes an upper portion 176 for receiving the bladed section 230 of a key, and a lower portion 178 for receiving the warded section 240 of the key 202. As illustrated in FIGS. 12-14, moveable locking members, such as wafers or pins 160 are located linearly along the length or depth of the keyway 156 resulting in a multitude of combination locking points that a cut key 202 must simultaneously defeat in order to allow the inner plug 154 to turn.

As is well known, these pins or wafers 160 are able to move with the aid springs 169 within limits established inside the channels or guide ways 167 machined into the lock's plug 154. The downward travel of these pins allows each pin to get to their lowest or locking and keyway interfering positions 170, but each pin is constrained in order to prevent the it from falling out of its travel channel 167. [[[Referring now to FIGS. 10A-11, FIGS. 10A-10B are side view illustrations of an exemplary single-edge cut key 202 (for use in accordance with the present disclosure) showing the humps 254, valleys 252, and details thereof relevant for the operation of the present disclosure. Similarly, FIG. 11 is a side view illustration of an exemplary dual-edge cut key 204 (for use in accordance with the present disclosure) also showing the humps 254, valleys 252, and other details thereof relevant for the operation of the present disclosure.

In general, a key shown as 200, whether a single-edge cut key 202 as in FIGS. 10A-10B, or a dual-edge cut key 204 as in FIG. 11, usually includes a rear or grip portion called the bow 210, and an elongate front or shaft portion 220 having two oppositely facing side surfaces 222, 223, an upper edge 224 and a lower or bottom edge 226. Each of the two oppositely facing side surfaces 222, 223, the upper edge 224 and the lower or bottom edge 226, each extend from the bow 210 to a distal end or tip 228 of the shaft portion 220.

In some cases however, the key as well as key blank as shown in FIG. 10A may include at least one waisting groove or recess 232 formed in at least one of the oppositely facing side surfaces 222, 223 and at a location adjacent to at least one of the upper and lower edges 224, 226 to form the key blade 234, 236 having a reduced thickness that is less than the general thickness of the shaft portion 220. The waisting groove 232 as such usually extends longitudinally along the shaft portion 220 from the bow or grip portion 210 to the distal end 228, thus causing a bladed section, for example an upper bladed section 230 that is coincident with a blade 234, to lie to the left or right of a vertical axis of the key shaft 220, as well as adjacent the upper edge 224.

Typically as illustrated in FIGS. 10A-11, a particular key is formed from a key blank by cutting or forming (in at least one or both of an upper and lower edges 224, 226 of blades 234, 236 of the shaft portion 220), a series of key cuts or bittings 250 that normally vary from one another in the their depths. The series of cuts or bittings 250 as illustrated in FIGS. 10B and 11 is comprised of a plurality of valleys 252 and humps 254 that alternate in the longitudinal direction of the shaft portion 220 from the grip portion 210 to the distal end 228 thereof. Each hump 254 has an apex 256 representing its highest point. Each apex (or appositely located apexes on the upper and lower edges in the case of a dual-edge cut key) forms a relatively wide section of the shaft portion. Each hump as such has a first slope S1 inclining for example upwards from a first adjacent valley 252 to the apex 256, and a second slope S2 (FIG. 11) declining from the apex 256 into a second adjacent valley 252.

On the other hand, each valley 252 has a root 258 representing its lowest point with each root or appositely located roots on the upper and lower edge surfaces forming “narrow sections” of the shaft portion 220. Each valley 252 as such also shares the two slopes S2 (which at the same time is the second slope to a first adjacent hump) declining for example downwards from the apex 256 of a first adjacent hump 254 to the root 258, and S1 (which at the same time is the first slope to a second adjacent hump) inclining upwards from the root 258 to the apex 256 of a second adjacent hump.

Specifically, as shown in FIGS. 10A-11, a single-edge cut or a dual-edge cut key 202, 204 respectively, has the rear portion or bow 210 for gripping or holding onto, and an elongate, thin front or shaft portion 220 extending forwardly of the bow 210. The front or shaft portion 220 includes first and second sides 222, 223, the blade edge or edges 224, 226, and a warded portion 240. The warded portion 240 includes a mechanical feature, for example a ward groove 242. The absence, presence and precision of such mechanical feature 242 allow or restrict what key will fit in what lock. The blade 234 and upper edge 224 typically include the bittings or cuts 250 that form the combinated mechanical code for correctly manipulating the pins or wafers 160 in a particular lock 150. The distal end or tip 228 of the front or shaft portion 220 of the key usually includes a double edge taper 260 (FIG. 10B), giving the tip 228 a pointed shape. This allows the key on being inserted into the keyway 156, to gradually and easily lift each of the pins or wafers 160 from their lowest at-rest position 170, and to allow the lifted pins in particular to ride up and down the cut edge 224 of the key blade 234.

In order to further assist the pins 160 to glide up and down the cut edge 224 of the key blade 234, cuts or bittings 250 are formed as the humps 254 and valleys 252 with tapered sides comprising rising or inclining slopes S1 (moving bow to tip) and falling or declining slopes S2. Each of the tapered sides or slopes S1, S2 thus acts as a ramp allowing the pins 160 to glide up and down the cut edge 224 of the key blade 234.

The cuts or bittings 250 on the blade 234 of the correct key are formed so as to coincide or be aligned with the positioning within the lock (FIG. 12) of the pins or wafers 160. The combination (combinating) effect of these cuts 250 is accomplished by creating a depth of a cut for each pin position that correctly positions the physical boundary between the upper pin 164, and lower pin 166 of each set of pins, at the shear line 168 or at a side-bar acceptance position. This allows all blocking features of these devices to be neutralized, and thereby enables rotational movement of the inner cylinder or plug 154.

As illustrated in FIG. 11, a dual-edge cut key 204 is comprised of the bow 210, a shaft portion 220 having two blades 234, 236, and instead of a warded section, it has a junction between the two blades. Dual-edge cut keys 204 as such are usually designed with identical cuts or bittings 250 on the bladed edges 224, 226 in order to allow a user the freedom to put the key in an upside down or downside up manner, and still have the key enter a single pin-series lock and operate the single series of pins therein. This freedom is particularly useful when trying to insert an automobile key into an automobile lock when it is dark. As further illustrated, a dual-edge cut key 204 is also useful in locks, such as wafer locks that have alternately dispersed wafers 160 on two opposite sides.

When forming cuts in a key blank to create a key, it will be noticed that the strength of the key is lessened or is least at the root or lowest point 258 of the deepest cut or valley 252, due to the cutting away of material. In the case of a dual-edge cut key with identical cuts on both edges 224, 226 this inherent weakness would be exaggerated due to the cut occurring on both sides of the key blank.

Given prolonged use, during which the sides of the key are worn out from being inserted, turned, twisted and withdrawn many times, it is common for some keys to break at the root or lowest point 258 of the deepest cut or valley 252 where the shaft of the key is relatively the narrowest. This is because the metal of the key shaft portion 220 has been fatigued by the normal habit of applying some rotational or twisting motion after insertion in order to operate the lock. Typically, the point of such a break lies a number of cuts forward of the bow 210 of the key, and hence the remnant or unbroken key portion of the broken key (that is, the portion of the shaft still attached to the bow) has a number of cuts in it too. As such, upon removing the bow and this unbroken key portion from the keyway, some pins 162 of the pins and wafers 160 that were initially held in their upwards or opening position by the cuts in the unbroken key portion, will now be released and fall to their at-rest or keyway interfering and locking positions 170 ahead or upstream of a broken key portion 270 that is still within the keyway. This effectively traps the broken key portion 270 within the keyway 156, and behind such released pins 162.

In other words, if cut keys or keys with bittings or cuts 250 formed in them break (when inserted into a lock and being turned in an attempt to open the lock), the break 272 will normally occur at a root 258 of a valley 252 (of the series of valleys and humps of the bittings) because the root 258 of the valley as such is one of the “narrow sections” of the shaft portion 220.

As such, it has been found (as illustrated in FIGS. 10, 11 and 14) that the unbroken key portion that is removable with the bow 210 typically ends with a declining or second slope S2 declining from an apex 256 of a hump into the root 258 of the valley where the break 272 occurred. On the other hand, the broken key portion 270 left within the keyway 156 and needing to be extracted, typically starts with a corner lip L1 or an inclining or first slope S1 inclining from the root 258 of the valley where the break 272 occurred upwardly to the apex 256 of the next hump. These findings are true for single-edge cut as well as double-edge cut keys. Because there is usually enough longitudinal spacing within each such root 258 in order for it to hold the bottom of a pin 166, a line break 272 will usually leave a corner lip L1 (FIG. 14) ahead of the inclining slope S1 on the broken key portion 270.

Accordingly, in order to extract the broken key portion 270 from behind the released pins 162, one must (1) reach into the keyway 156, (2) raise the released pins or wafers 162 that are blocking the broken key portion 270 within the keyway, (3) grasp the broken key portion, and (4) withdraw the broken key portion while keeping the released pins 162 out of its way. Such a multiple tasked activity can be difficult and is conventionally accomplished with two hands, three tools, and with a flashlight in ones mouth in order to facilitate viewing of these critical elements all at the same time. This difficulty is increased even more in the case of a dual-edge cut automotive key where wafers must be withheld from two directions while attempting to grasp and extract the broken key portion.

Referring now to FIGS. 1-7 and 12-13, a first embodiment and a second embodiment of the side acting extractor tool 300, 301 of the present disclosure are illustrated and are each suitable in general for extracting a clearance-fitting, loose item from a slot defined in part by slot side walls. In particular, each is suitable for extracting a broken key portion from a keyway.

In a first embodiment of the side acting extractor tool 300 (FIGS. 1-4), the first edge 334 extends from the first end 316 to the second and distal end 318 of the blade member, and the second and opposite edge 336 includes the finger portion 320. In a second embodiment of the side acting extractor tool 301 (FIGS. 5-7), the first edge 334 extends from the first end 316 to the second and distal end 318 of the blade member, and the second and opposite edge 336 also extends from the first end 316 to the second and distal end 318 of the blade member, with the finger portion 320 located therebetween.

As shown, the side acting extractor (SAE) tool 300, 301 includes a handle member 312, and a blade member 314 for inserting into the slot or keyway 156 and through a clearance gap 181 (FIG. 13B) between the loose item 270 and one of the keyway or slot side walls 172, 173 (FIG. 12). The blade member 314 has a longitudinal axis 313, a first end 316 for connecting to the handle member 312, and a second and distal end 318 for inserting into the slot or keyway 156 containing the item or broken key portion 270.

The blade member 314 is generally flat and includes first and second sides 328, 329, a first edge 334, and a second and opposite edge 336. The first edge 334 extends from the first end 316 to the second and distal end 318 of the blade member 314, and the second and opposite edge 336 may (as in the second embodiment FIG. 7) or may not (as in the first embodiment FIG. 4) extend continuously from the first end 316 to the distal end 318. In each embodiment however, the second and distal end 318 includes a finger portion or barb 320 for contacting and pulling against a contact area, including a key bitting slope S2 on the broken key portion 270. The finger portion or barb 320 extends or is extendable an angle Af relative to the longitudinal axis 313 to at least one side of the first side 328 and the second and opposite side 329. Extended as such, the finger portion 320 is suitable for contacting or wedging against a section, part or area of the broken key portion 270 within the keyway 156 when properly inserted and being pulled back out of such keyway as described below. Such proper insertion and pulling back as described below effectively enables extraction of the wedged, broken key portion 270 from the keyway by withdrawing the inserted blade member from the keyway or slot. Thus in one embodiment, it can be seen that the deflectable finger portion is formed between the first edge and the second and opposite edge, and has a first finger end attached towards the distal end of the blade member, and a cantilevered second finger end pointing towards the first end of the blade member, thereby enabling such wedging and extraction of the loose item from the slot by withdrawing the inserted blade member from the slot or keyway.

The blade member 314 in operation first fits within the part of the keyway left behind by the removed unbroken key portion of the key. The blade member 314 has a shim-like thickness T2 that is small enough to let it fit through a clearance gap 181 (FIG. 13B) between a side 328, 329 of the broken key portion 270, and that side wall 172, 173 of the keyway that is nearest such side 328, 329. The height or width of the blade member 314 is also narrow enough to allow it to fit under the lowest drop point 170 of the released pins or wafers 162 within the keyway. As shown in FIG. 3, the finger portion or barb 320 normally is formed to have a memory position P1, P1′ extending to a side 328, 329 of the blade member 314. The finger portion or barb 320 is then deflectable from the memory position P1, P1′ into a deflected position P2 generally coincident with the longitudinal axis 313 of the blade member 314. In other words, the finger portion 320 is deflectable from a sideways extended position P1 into a non-extended position P2 relative to the first side and the second and opposite side of the blade member 314.

The finger portion 320 is made of a spring material. The finger portion is deflectable by a deflecting force from the extended position P1 into the deflected position P2, and is freely returnable towards the home position P1 from the deflected position when free of the deflecting force. Given the rearwards pointing and flaring design of the finger portion 320, forward force insertion thereof into a clearance gap 181 that is narrower than the distance from the tip 321 of the finger portion to the axis 313, will cause the walls forming the clearance gap 181 to apply a deflecting force as above to the finger portion 320. The deflected finger portion 320 is thus under tension and tendency to return towards the memory and home position P1 where there is room to do so. Such room typically will exist where there is a valley 252 with a declining slope S2, or at the nose 228 of the key where there is an inclining slope Sd or a declining slope Su (FIGS. 10B and 11).

As such, it is possible with one hand (a) to insert the blade member 314 of the side acting extractor tool 300, 301 below the released pins 162 and through the clearance gap 181 (FIG. 13B) into the keyway 156 along side the broken key portion 270, (b) to raise and if need be, angle the blade member 314 while lifting the released blocking pins or wafers 162 out of the way of the broken key portion, (c) to move the extractor blade member 314 forwardly, angling where necessary, in order pass underneath any partially supported pins 163 on the broken key portion, and to position the tip 321 of the finger portion 320 behind an edge such as the declining slope S2 or behind a nose edge Su, Sd of the broken key portion 270, (d) to then pull backwards, thereby hooking or wedging such edge of the broken key portion within the V-shaped or U-shaped cut 335 of the finger portion 320, and thus withdrawing the broken key portion 270 from the keyway, with the first or top edge 334 of the blade member 314 keeping the released but lifted pins 162 out of the way.

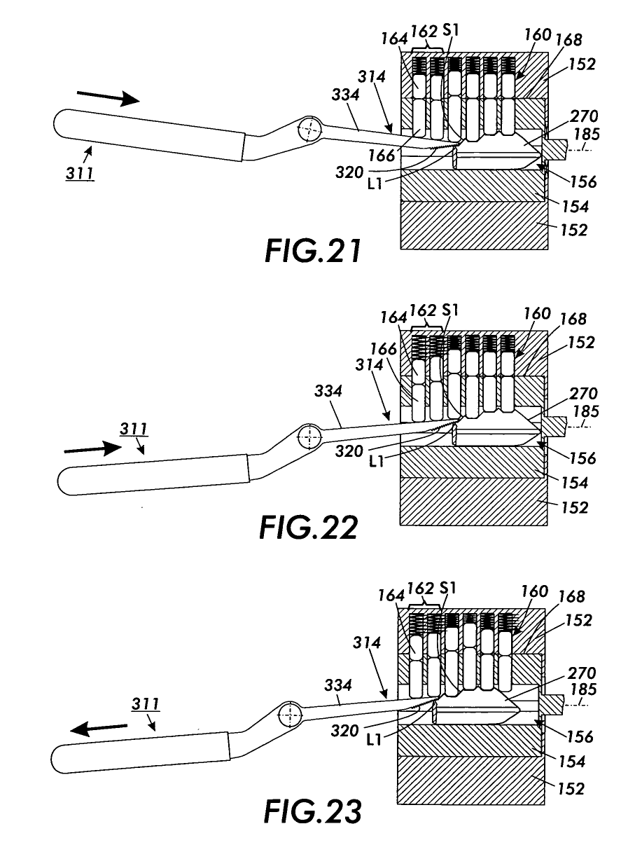

Ordinarily, a user employs the first edge 334 (that is, the long non-bard edge of the blade member of the SAE tool), to lift and hold up the released pins 162 during the pulling back or during the extracting of the broken key portion 270. However, as shown in FIG. 21, when the side acting extractor tool 300, 301 is used to wedge a bottom edge such as the inclining slope Sd, an auxiliary tool 400 may be used to hold the released tumblers 162 out of the way of the broken key portion 270 being pulled out. The auxiliary tool 400 may any suitable tool having a blade member 412 that includes and edge 434 suitable for holding up the bottoms of the lower pins 166. Although not shown, this is true of FIGS. 19 and 20 illustrations.

As pointed out above, during insertion of the blade member 314 through the clearance gap 181 between a side of the broken key portion 270, the usually side extending barb or finger portion 320 is deflected from its side extending memory position P1, P1′ into a straight alignment with the rest of the blade member 314. However, it remains under tension with a tendency to return towards the memory position P1, P1′. As shown in FIG. 13B, because the bottom pins 166 are wider than the blade 234 of the broken key portion, the pins 166 overhang such blade 234 and thus cover part of the clearance gap 181 on either side of the broken key portion 270 (FIG. 13B). Thus after insertion, raising or lifting the first or second edge 334 of the blade member 314 will cause it to contact and hence lift the released pins 162, including those 163 sitting in any cut 250, 251 on the broken key portion. Note that the deflected bard or finger 320 being under tension to return to its memory position P1, P1′, is constantly pushing against the side of the broken key portion during insertion, and is thus looking for any opening such as a valley 252 or nose end 228 of the key, to snap or kick back into, or to attack and wedge.

The side acting extractor tool thus works by the tip 321 of the deflected finger or barb 320 snapping, snagging or kicking out into an opening (S2, Su, Sd) from the deflecting side of the broken key portion into the keyway. The opening can be a valley 252 in a key cut or bitting 250, or it can be the nose 228 of the key. In order for the opening to be the nose of the broken key portion, the tip 321 of the finger portion 320 has to be inserted past the declining slope Su or inclining slope Sd.

In the case where there are no deep valleys in the cuts to snag or snap back into, the side acting extractor tool will only work on the nose 228 of the broken key portion. In such a case, the user must keep going forward until the tip 321 of the finger portion 320 is in front of and past the nose 228 of the key. The tool ordinarily should be used with the first edge up for lifting and holding pins 160 out of the way. It could however also be used along with an auxiliary tool 400 as described above, with the second edge up, in the embodiment of the tool in which the finger portion 320 is formed between the first and second edges 334, 336 and into the body portion 315 of the blade member 314.

As shown in FIG. 13B, it must be noted too that the tumbler pins 160 are wider than the key blade 234, therefore within the keyway 156, there is a side-to-side overhang 323, 325 of the bottom end of each pin 166 as shown in FIG. 13B. As such, within the keyway 156 the bottom of each pin 166 sits over the blade portion 234 of the key and over the clearance gap 181 on each side of the key. In fact, the portion of each pin that intrudes into the keyway itself has a clearance fit within such keyway. As such, the thin shim-like blade member 314 of the side acting extractor (SAE) tool of the present disclosure is therefore able to fit within the clearance gap 181 on either side and below the lowest point 170 of pins within the keyway with the ordinarily side-extending spring finger 320 deflected into a straight-edge position P2 with the rest of the body portion 315. The side extending spring finger 320 when deflected as such is under tension and so its tip is continuously pushing against the side of the broken key portion looking for any opening or give in the side of the broken portion to push itself free and thereinto.

Therefore, in operation, the blade member 314 of the SAE tool can be inserted below the tumbler pins and all the way into the keyway before being raised or lifted upwardly against the hanging bottoms of all the tumbler pins 166. Raising or lifting the blade member 314 as such will cause the upside edge 334 or 336 of the blade member 314 to contact and lift the released pins 162 with it. The same edge 334, 336 will also contact the overhang 323 or 325 of the bottom of those pins 163 still sitting within the valley 258 of a key cut or bitting 250 on the broken key portion, and also start to lift these pins out of such key cuts or bittings thereby creating an opening, which is just what the deflected spring finger 320 under tension is looking for. A slight movement of the blade member back and forth usually will quickly find one such opening, and the deflected finger 320 will quickly snap into it to be free of the tension within the clearance gap 181. Thereafter, any backward pull on the SAE tool will cause the finger 320 within such opening to catch against, hook or wedge the declining edge S2 of the key cut or bitting into which it released or snapped.

As shown in FIGS. 19-21, in cases where cuts or bittings 250 in the broken key portion are too shallow for effective top approach in extraction as above, the blade member 314 may be inserted at the bottom and all the way beyond the front tip or nose 228 of the broken key portion 270 in order to allow the deflected, tensioned finger portion 320 to snap or release into the opening (within the keyway 156) at the very end of the broken key portion. The blade member 314 may also be inserted as such in cases when the fit of the key 202 into a keyway 156 leaves no side clearance or a side clearance gap that is wide enough to allow insertion of the side acting extractor tool directly against a side of the broken key portion in the keyway. Backward movement of the SAE tool after this will cause the finger portion 320 to catch against, hook or wedge the inclining edge Sd of the front tip or nose 228 of the broken key portion, thereby enabling capture and extraction of the broken key portion. As shown in FIG. 21 and pointed out above, when the side acting extractor tool 300, 301 is used to wedge a bottom edge such as the inclining slope Sd, an auxiliary tool 400 may be used to hold the released tumblers 162 out of the way of the broken key portion 270 being pulled out. The auxiliary tool 400 may any suitable tool having a blade member 412 that includes and edge 434 suitable for holding up the bottoms of the lower pins 166. Although not shown, this is true of FIGS. 19 and 20 illustrations.

As shown in FIGS. 22-24, again in cases where cuts or bittings 250 in the broken key portion are too shallow for effective top approach in extraction as above, the blade member 314 may be inserted at the top and all the way beyond the front tip or nose 228 of the broken key portion 270 in order to allow the deflected, tensioned finger portion 320 to snap or release into the opening (within the keyway 156) at the very end of the broken key portion. Backward movement of the SAE tool after this will cause the finger portion 320 to catch against, hook or wedge the declining edge Su of the front tip or nose 228 of the broken key portion, thereby enabling capture and extraction of the broken key portion.

Thus there are three or so possible ways to attack a broken key portion 270 for extraction from a keyway 156, using the side acting extractor tool 300, 301. The first is an attack from either side of the broken key portion using a deep valley or cut 252 as the opening for the tensioned tip 321 of the deflected finger portion to kick out into. The second is an attack along the top of either side of the broken key portion 270 with the declining edge Su of the nose 228 of the broken key portion 270 as the target. The third is an attack along the bottom of either side of the broken key portion 270 with the inclining edge Sd of the nose 228 of the broken key portion 270 as the target. When attacking from the bottom, it will be necessary to use some second tool (FIG. 21) such a prior art tool 400, to raise and hold the released pins 162 out of the way when pulling back the broken key portion 270. When inserting the blade member 314 as above, a ramp 340 (FIG. 4) at the tip or distal end 318 of the blade member 314 will pry under and raise the pins 160 including the released pins 162, so as to allow for the withdrawal of the broken key portion.

Due to the design of some key blanks and some keyways, the clearance gap 181 may be greater to one side of the broken key portion 270 than to the other side thereof. As such, it may be easier to insert the blade member 314 into one side of the broken key portion within the keyway than into the other side. The user is encouraged to find which side works better, however it should be noted that the side acting extractor tool 300, 301 works equally well from either side of the broken key portion, provided of course the blade member is inserted with the deflectable finger portion against the broken key portion 270. As further shown in FIG. 4, the end 318 of the finger portion 320 includes a taper 322 resulting in a sharp tip 321 that when kicking out into the bottom part of a valley or deep cut 252 on a broken key portion 270, will gradually ramp and start to lift any pin 166 sitting on such cut or valley.

To recapitulate, the penetrating part or blade member 314 of the SAE tool of the present disclosure has a length that is generally longer than most key blanks in order to allow for various attack plans. As already described, it includes the bendable or deflectable barb or finger portion 320 that is shaped and located along its length so as to enable different methods and positions of attack on the broken key portion 270. In one embodiment thereof the finger portion 320 is located near the distal end 318. The blade member 314 has a shim-like thinness in order to allow it to fit through a narrow clearance gap 181 between a side of a broken key portion and a wall of the key way. The blade member 314 also has a height or width Wb that is relatively very short or narrow in order to allow it to fit only through the top or bottom blade portion 182 of the key way 156.

The blade member 314 is made of a spring material, for example spring steel for providing lateral strength sufficient to pull the broken key portion out of the keyway. The finger portion 320 is made of the same spring material and has a set memory position P1, P1′ angled, and extending sideways as illustrated in FIG. 3, from a side 328, 329 of the blade member 314. As such, the finger portion 320 can be deflected from the side extending memory position P1, P1′ into a tensioned, deflected position P2 where it is straight and aligned with the rest of the body portion 315 of the blade member 314. When deflected as such, the finger portion 320 is constantly seeking to spring back into its memory position P1, P1′. As illustrated in FIG. 3 for example, in operation, the user can further bend such spring-back barb or finger 320 to a suitable displacement from a side of the blade member 314 as required by the job at hand.

The finger portion 320 includes the tip section 321 pointing towards the first end 316 of the blade member 314. Thus as shown in FIGS. 3 and 4, the finger portion includes (i) a bottom section 331 that is attached to the at least one side 328, 329 of the blade member 314, and towards the distal end 318, and (ii) the tip section 321, that when in the memory position P1, P1′, extends angularly at an angle Af, Af′ towards the first end 316 of the blade member 314. The finger portion 320 is made of a spring material and is deflectable from its sideways extending memory position P1, P1′ into the non-extended position P2 relative to a side 328, 329 of the blade member. It is deflectable into the deflected position P2 as such from the home position P1, P1′ by a deflecting force, (for example a force from rubbing against a side 328, 329 of the broken key portion 270 during insertion). The spring material is chosen so that when deflected, it will tend to, and freely return to the home position from a deflected position when free of the deflecting force.

For forming the finger portion 320 from the blade member 314, the blade member as shown in FIG. 4, includes a generally L-shaped cut 338, for example an L-shaped slot, from the second and opposite edge 329 for example, into a body portion 315 of the blade member 314. In another embodiment as shown in FIG. 7, the finger portion 320 is formed by including a generally U-shaped cut 342 into the body portion 315 of the blade member. As shown, the U-shaped cut is located between the first edge 334 and the second and opposite edge 336. The U-shaped cut for example can be a U-shaped slot.

In order to prevent the tip 321 of the finger portion from snagging undesirably against an opposite keyway wall (that is, the keyway wall on the opposite of the broken key portion 270 from the blade member), the tip section 321 is spaced a desired distance that is less than the width W1 of the keyway 156.

In accordance with an aspect of the present disclosure, the blade member 314 has a first side to second side shim-like thickness T2 of about 0.025 inch, that is narrow enough for enabling insertion through the clearance gap 181 between the broken key portion 270 and a keyway side wall 172, 173. As pointed out above, the blade member 314 further has a maximum first edge to second edge dimension Wd that is short enough for enabling it to be insertable in a space within the keyway below the released tumbler pins 162 in the keyway.

In a further aspect of the present disclosure, the tip section 321 of the finger portion 320 includes a double taper 322 for ensuring a sharp effective contact against a declining slope S2 for example, of the at least couple of key bitting slopes.

As can be seen, there has been provided a side acting extractor tool that is suitable for extracting from a keyway a broken key portion of a cut key. The side acting extractor tool includes a handle member; a blade member having a first end for connecting to the handle member, and a second and distal end for inserting into the keyway containing the broken key portion. The blade member is made of a spring material having a shim-like thickness for inserting into a clearance gap between the broken key portion and a wall of the keyway. The blade member also includes a longitudinal axis, and a deflectable finger portion having a memory position and extending sideways at an angle from the longitudinal axis for hooking against a part of the broken key portion, thereby enabling extraction of the broken key portion from the keyway by withdrawing the inserted blade member from the keyway.

What is claimed is:

1. A side acting extractor tool for extracting a loose item from a slot defined in part by slot side walls, the extractor tool comprising:
(a) a handle member; and
(b) a blade member for inserting into the slot and through a clearance gap between the loose item and one of the slot side walls, the blade member having a longitudinal axis and including:
(i) a first end attached to said handle member;
(ii) a second end opposite said first end and forming a distal end;
(iii) a first side, and a second and opposite side;
(iv) a first edge, and a second and opposite edge; and
(v) a deflectable finger portion extendable from said longitudinal axis to at least one side of said first side and said second and opposite side for positioning behind a part of the loose item within the slot, thereby enabling extraction of the loose item from the slot by withdrawing the inserted blade member from the slot.

2. The side acting extractor tool of claim 1, wherein said finger portion includes a tip section pointing towards said first end of said blade member.

3. The side acting extractor tool of claim 1, wherein said finger portion is located near said distal end.

4. The side acting extractor tool of claim 1, wherein said finger portion includes:
(i) a bottom section attached to said at least one side of said blade member and towards said distal end; and
(ii) a tip section extending angularly towards said first end of said blade member.

5. The side acting extractor tool of claim 1, wherein said blade member is made of a spring material.

6. The side acting extractor tool of claim 1, wherein said finger portion is deflectable from a sideways extended position into a non-extended position relative to said first side and said second and opposite side of said blade member.

7. The side acting extractor tool of claim 1, wherein said finger portion is made of a spring material, has a home position extended sideways from at least one side of said first side and said second and opposite side, is deflectable by a deflecting force into a deflected position from said home position, and is freely returnable to said home position from said deflected position when free of said deflecting force.

8. The side acting extractor tool of claim 1, wherein said blade member includes a body portion having a generally L-shaped cut into said body portion for forming said finger portion.

9. The side acting extractor tool of claim 1, wherein said blade member includes a body portion having a generally U-shaped cut formed between said first edge and said second and opposite edge and into said body portion of said blade member for forming said finger portion.

10. The side acting extractor tool of claim 2, wherein said tip section is spaced a distance less than a width of the keyway from said at least one side of said first side and said second and opposite side of said blade member.

11. The side acting extractor tool of claim 8, wherein said L-shaped cut is formed from said second and opposite edge into said body portion.

12. The side acting extractor tool of claim 8, wherein said L-shaped cut comprises an L-shaped slot.

13. The side acting extractor tool of claim 9, wherein said U-shaped cut is formed from said second and opposite edge into said body portion.

14. The side acting extractor tool of claim 9, wherein said U-shaped cut comprises a U-shaped slot.

15. A side acting extractor tool for extracting, from a keyway defined in part by keyway side walls, a broken key portion of a cut key, the side acting extractor tool comprising:
(a) a handle member; and
(b) a blade member for inserting into the keyway and through a clearance gap between the broken key portion and one of the keyway side walls, the blade member having a longitudinal axis and including:
(i) a first end attached to said handle member;
(ii) a second end opposite said first end and forming a distal end;
(iii) a first side, and a second and opposite side;
(iv) a first edge, and a second and opposite edge; and
(v) a deflectable finger portion extending from said longitudinal axis to at least one side of said first side and said second and opposite side for wedging against a part of the broken key portion within the keyway against said at least one side of said first side and said second and opposite side, thereby enabling extraction of the wedged broken key portion from the keyway by withdrawing the inserted blade member from the keyway.

16. The side acting extractor tool of claim 15, wherein said finger portion includes a tip section for catching against a declining slope of a key bitting slope of said broken key portion.

17. The side acting extractor tool of claim 15, wherein said blade member is generally flat.

18. The side acting extractor tool of claim 15, wherein said blade member is made from spring steel for providing lateral strength sufficient to pull the broken key portion out of the keyway.

19. The side acting extractor tool of claim 15, wherein said first edge extends from said first end to said second end of said blade member, and said second and opposite edge includes said deflectable finger portion.

20. The side acting extractor tool of claim 15, wherein said deflectable finger portion is located between and spaced from said first edge and said second and opposite edge.

21. The side acting extractor tool of claim 15, wherein said blade member has a first side to second side shim-like thickness narrow enough for enabling insertion thereof through a clearance gap between the broken key portion and a keyway side wall.

22. The side acting extractor tool of claim 15, wherein said blade member has a maximum first edge to second edge dimension short enough for enabling it to be insertable into a space within the keyway below released tumblers in the keyway.

23. The side acting extractor tool of claim 15, wherein said first edge is wide enough for lifting and supporting released tumblers during insertion and removal thereof from the key way.

24. The side acting extractor tool of claim 22, wherein said shim-like thickness is about 0.025 inch.

25. A side acting extractor tool for extracting a loose item from a slot defined in part by slot side walls, the extractor tool comprising:
(a) a handle member; and
(b) a blade member for inserting into the slot and through a clearance gap between the loose item and one of the slot side walls, the blade member having a longitudinal axis and including:
(i) a first end attached to said handle member;
(ii) a second end opposite said first end and forming a distal end;
(iii) a first side, and a second and opposite side;
(iv) a first edge, and a second and opposite edge; and
(v) a deflectable finger portion extending from said longitudinal axis to at least one side of said first side and said second and opposite side for positioning behind a part of the loose item within the slot, said deflectable finger portion being formed between said first edge and said second and opposite edge, and having a first finger end attached towards said distal end of said blade member, and a cantilevered second finger end pointing towards said first end of said blade member, thereby enabling wedging and extraction of the loose item from the slot by withdrawing the inserted blade member from the slot.
